(19) United States
(12) Patent Application Publication
(10) Pub. No.: US 2007/0224324 A1
(43) Pub. Date: Sep. 27, 2007

(54) Generation of Starchy Products

(75) Inventors: Stephane Jules Jerome Debon, Bruxelles (BE); Bernd Wolfgang Kettlitz, Bonheiden (BE); Jozef Victor Jean Marie Coppin, Denderleeuw (BE); Eric Philippe Jean-Pierre Delepine, La Chapelle d'Amentieres (FR); Pierre Jean Albert Kesteloot, Sainghin en Weppes (FR)

Correspondence Address: FISH & RICHARDSON P.C., PO BOX 1022, MINNEAPOLIS, MN, 55440-1022, US

(73) Assignee: Cargill-Cerestar, Wayzata, MN (US)

(21) Appl. No.: 11/578,615

(22) PCT Filed: Apr. 12, 2005
(86) PCT No.: PCT/EP05/03829

§ 371 Date: Oct. 16, 2006

(30) Foreign Application Priority Data
Apr. 16, 2004 (EP) 04252233.4

(51) Int. Cl. A23L 1/00; C08B 30/14

(52) U.S. Cl. 426/550; 536/102

(57) ABSTRACT

The current invention relates to non-lumping granular cold water swellable starch that when dispersed in water at a temperature of at least 95° C. develops its full viscosity in less than 30 seconds (at a concentration above 3%) and a process for preparing them. These products can be used in food products, feed products, cosmetics, pharma products, agrochemicals, and industrial applications.

### TECHNICAL FIELD

The current invention relates to non-lumping instant thickening starches, with applications in food, feed, pharma and the like. A process for preparing these starches is disclosed as well.

### BACKGROUND

So far it is known that the dispersibility of instant starches can be improved by either of the following methods: physical treatment, adding surface-active agents or adding food-grade bulking agents such as maltodextrins, sugars, fibers and the like.

EP 0 436 208 describes a heat-moisture treatment of starch.

WO 01/19404 describes delayed viscosity development or thin-thick behaviour (development of viscosity after shear) by partial pregelatinisation of highly crossbonded potato starch.

WO 00/75192 relates to cold water swellable starches exhibiting delayed viscosity development after roll compaction and as such lump formation is reduced.

U.S. Pat. No. 3,443,990, and U.S. Pat. No. 3,582,350 each describe the addition of surfactant and/or emulsifiers.

U.S. Pat. No. 4,361,592, and EP 1 166 645 describe the addition of a kind of bulking agent to improve the dispersibility of instant starches.

However, there is still a need for a starch-based thickener with a large swelling power and at the same time providing a lump-free viscous paste when using hot or boiling water containing liquids.

The current invention provides such a product.

### SUMMARY OF INVENTION

The current invention relates to a non-lumping granular cold water swellable starch that when dispersed in water at a temperature of at least 95° C. develops its full viscosity in less than 30 seconds (at a concentration of at least 3%). It is dispersible in cold water, or in water of a temperature of at least 95° C. When dispersed in water at a temperature of at least 95° C. its full viscosity is developed in less than 30 seconds, preferably in less than 20 seconds, more preferably in less than 15 seconds. The granules of the starch remain intact upon dispersing in cold water, or water of a temperature of at least 95° C. When dispersed in water at a temperature of at least 95° C. its viscosity (at a concentration of at least 3%) is already higher than 4500 mPa·s, preferably higher than 5000 mPa·s more preferably higher than 5500 mPa·s.

Said starch is obtained from a source selected from the group consisting of native leguminous starch, native cereal starch, native root starch; native tuber starch, native fruit starch, modified leguminous starch, modified cereal starch, modified root starch, modified tuber starch, modified fruit starch, waxy type starches, high amylose starches and mixtures thereof. Said modified starch is obtained by a modification selected from the group consisting of bleaching, esterification, etherification, phosphorylation and combinations thereof.

The current invention further relates to a process for preparing a non-lumping granular cold water swellable starch that when dispersed in water at a temperature of at least 95° C. develops its full viscosity in less than 30 seconds (at a concentration of at least 3%) and said process comprises the following steps:
a₁. Bleaching of starch,
b. Treating said starch of step a₁) with a treatment selected from the group consisting of spray-cooking/drying, roll-drying, pregelatinisation with aqueous alcohols and combinations thereof, preferably spray-cooking/drying.

The current invention relates to a process for preparing a non-lumping granular cold water swellable starch that when dispersed in water at a temperature of at least 95° C. develops its full viscosity in less than 30 seconds and having a Brookfield viscosity higher than 4500 mPa·s at 3% concentration in demineralised water at 20° C. and said process is comprising the following steps:
a₁ Bleaching of starch,
b. Treating said starch of step a₁) by a treatment selected from the group consisting of spray-cooking/drying, roll-drying, pregelatinisation with aqueous alcohols and combinations thereof, preferably spray-cooking/drying.

The current invention relates to a process comprising the following steps:
a₁. Bleaching of starch,
a₂. Chemically modifying starch,
   b. Treating the starch wherein said treatment is selected from the group consisting of spray-cooking/drying, roll-drying, pregelatinisation with aqueous alcohols and combinations thereof, preferably spray-cooking/drying,

In a further preferred embodiment, the process comprises:
a₁) Bleaching of starch,
a₂) n-alkenyl-succinylation, with n-alkenyl-succinic anhydride, preferably n-octenylsuccinylation with n-octenylsuccinic anhydride,
   wherein the order of step a₁) and a₂) is interchangeable, or wherein step a1) and a2) occur simultaneously.

Furthermore, it relates to a process wherein in step a₁) bleaching is taking place with reactant that is capable of forming active chlorine under alkaline conditions. The active chlorine is present in an amount of from 100 to 4000 ppm and the alkaline conditions are defined by a pH between 7.5 and 11.5.

The current invention further relates to a process comprising the following steps:
a₁. Bleaching of starch with active chlorine present in an amount of from 100 to 4000 ppm at a pH between 7.5 and 11.5
a₂. n-octenyl-succinylation with n-octenylsuccinic anhydride,
b. Spray-cooking/drying of bleached n-octeny-succinylated starch, wherein step a₁) and a₂) occur simultaneously or wherein step a₂) occurs before a₁).

Furthermore the current invention relates to the use of non-lumping granular cold water swellable starch that when dispersed in water at a temperature of at least 95° C. develops its full viscosity in less than 30 seconds (at a concentration of at least 3%) in food products, feed products, cosmetics, pharma products, agrochemicals, and industrial applications.

Said food products are selected from the group consisting of soups, sauces, desserts, dressings, bakery products, and sauce binders. The feed products are selected from the group consisting of pet foods, fish feed, and piglet feed. The pharma products are selected from the group consisting of excipient in tablets, thickeners for syrups, and liquors.

In addition, the current invention relates to the use of non-lumping granular cold water swellable starch that when dispersed in water at a temperature of at least 95° C. develops its full viscosity in less than 30 seconds (at a concentration of at least 3%) to reduce skin formation.

### DESCRIPTION OF FIGURE

FIG. 1 is a picture taken from a dispersion of 15 g starch of the current invention (spray-dried C⋆EmTex 06328) in 500 ml still mineral water (pH 6.0; Spa™, Belgium) at a temperature of at least 95° C. No lumps are observed.

FIG. 2 is a picture taken with light microscope (×100): after dispersion in mineral water at a temperature of at least 95° C. Intact swollen granules in suspension are seen.

### DETAILED DESCRIPTION

The current invention relates to a non-lumping granular cold water swellable starch that when dispersed in water at a temperature of at least 95° C. develops its full viscosity in less than 30 seconds (at a concentration of at least 3%).

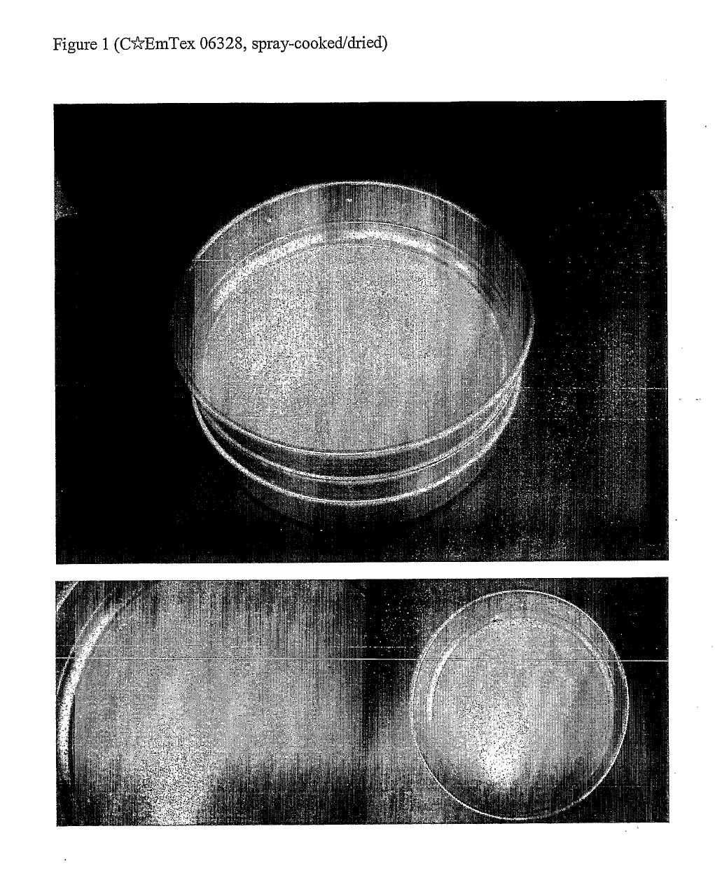

The fact that the starch is non-lumping can be observed by dispersing in one go 15 g of starch in 500 ml still mineral water of a temperature of at least 95° C. For 1 minute the dispersion is stirred and then it is poured on a sieve of 355 μm. FIG. 1 is a picture taken with digital camera and demonstrate the effect to be seen, i.e. no lumps are formed. The starch of the current invention is dispersible in cold water, or in water of a temperature of at least 95° C. When dispersed in water at a temperature of at least 95° C. its viscosity (at a concentration of at least 3%) is already higher than 4500 mPa·s, preferably higher than 5000 mPa·s more preferably higher than 5500 mPa·s. Actually while dispersing, its viscosity (measured with Brookfield) is developed instantly, i.e in less than 30 seconds, preferably in less than 20 seconds, more preferably in less than 15 seconds. Development of its full viscosity can further be explained in that there is no post-thickening effect observed, or no delayed viscosity development. The granules of the starch remain intact upon dispersing in cold water, or water of a temperature of at least 95° C.

Cold water swellable starches are defined as starches which, when added to cold water, will rapidly disperse into water and swell to form a viscous paste. The temperature of the cold water is not higher than room temperature (20-25° C.).

The purpose of the present invention is to provide starch-based thickeners, emulsifiers, water-binders, suspending agents, clouding agents, and the like, which have a good dispersibility in cold, hot and boiling water-containing fluids (i.e. lump-free) without the need of adding a dispersant (e.g. surface-active, bulking agents, and the like) or without submitting the starch to a downstream physical treatment (e.g. compaction, or post-agglomeration, and the like).

The starch of the current invention is granular, cold water swellable but not cold water soluble due to the intact granular structure.

The Brookfield viscosity of the starch of the current invention is extremely high, i.e higher than 4500 mPa·s, preferably higher than 5000 mPa·s, more preferably higher than 5500 mPa·s at 3% concentration (percentage is each time referring to dry substance) in demineralised water at 20° C. (10 rpm, spindle 2). This viscosity is completely different from the viscosity of enzyme modified starches according to the process described in U.S. Pat. No. 4,035,235, which have a viscosity of between 125 to 500 mPa·s at 30% concentration at 25° C.

The starch used as a base material for the current invention is obtained from a source selected from the group consisting of native leguminous starch, native cereal starch, native root starch, native tuber starch, native fruit starch, modified leguminous starch, modified cereal starch, modified root starch, modified tuber starch, modified fruit starch, waxy type starches, high amylose starches and mixtures thereof. Actually, the starches and flours (hereinafter “starch”) preferably starches, used as the base material in the current invention can be derived from any native source, wherein native relates to the fact that said starch is found in nature. Typical sources for the starches are cereals, tubers, roots, legumes, fruit starches and hybrid starches. Suitable sources include corn, pea, potato, sweet potato, sorghum, banana, barley, wheat, rice, sago, amaranth, tapioca, arrowroot, canna, and waxy (containing at least about 95% by weight amylopectin) or high amylose (containing at least 40% by weight amylose) varieties thereof. Also suitable are starches derived from a plant obtained by breeding techniques including crossbreeding, translocation, inversion, transformation or any other method of gene or chromosome engineering to include variations thereof. In addition, starch derived from a plant grown from artificial mutations and variations of the above generic composition which may be produced by known standard methods of mutation breeding are also suitable herein.

Chemical modifications are intended to include without limitation crosslinked starches, acetylated and organically esterified starches, hydroxyethylated and hydroxypropylated starches, phosphorylated and inorganically esterified starches, cationic, anionic, oxidized starches, zwitterionic starches, and succinate and substituted succinate derivatives of starch and combinations thereof.

In a further embodiment the current invention further relates to a non-lumping granular cold water swellable starch that when dispersed in water at a temperature of at least 95° C. develops its full viscosity in less than 30 seconds (at a concentration of at least 3%) obtainable by spray cooking/drying and a modification selected from the group consisting of bleaching, esterification, etherification, phosphorylation and combinations thereof, preferably, the starch is obtained by bleaching n-alkenyl-succinylation, and spray-cooking/drying more preferably by bleaching n-octenyl-succinylation and spray-cooking/drying. The spray-cooking/drying can equally be a treatment selected from the group consisting of spray-cooking/drying, roll-drying, pregelatinisation with aqueous alcohols and combinations thereof, preferably spray-cooking/drying.

Physically modified starches such as thermally inhibited starches may also be suitable for use herein, as base material.

The starch obtainable according to the process disclosed in EP 0811633, is a preferred source of the starch used for the further treatment, i.e. spray-cooking/drying, roll-drying, pregelatinisation with aqueous alcohols and combinations thereof, preferably spray-cooking/drying.

The current invention further relates to a process for preparing a non-lumping granular cold water swellable starch that when dispersed in water at a temperature of at least 95° C. develops its full viscosity in less than 30 seconds (at a concentration of at least 3%) and said process is comprising the following steps:
a₁. Bleaching of starch,
b. Treating the starch wherein said treatment is selected from the group consisting of spray-cooking/drying, roll-drying, pregelatinisation with aqueous alcohols and combinations thereof, preferably spray-cooking/drying,
c. Obtaining a non-lumping granular cold water swellable starch that when dispersed in water at a temperature of at least 95° C. develops its full viscosity in less than 30 seconds (at a concentration of at least 3%) and wherein the order of step a₁) and a₂) is interchangeable, or wherein step a₁) and a₂) occur simultaneously.

Eventually alkali roasting can be applied as well as a process step.

The process of the current invention does not involve a viscosity reduction step such as thinning, enzymatic degradation and the like.

The current invention relates to a process for preparing a non-lumping granular cold water swellable starch that when dispersed in water at a temperature of at least 95° C. develops its full viscosity in less than 30 seconds and having a Brookfield viscosity higher than 4500 mPa·s at 3% concentration in demineralised water at 20° C. and said process is comprising the following steps:
a₁. Bleaching of starch,
b Treating said starch of step a₁) by a treatment selected from the group consisting of spray-cooking/drying, roll-drying, pregelatinisation with aqueous alcohols and combinations thereof, preferably spray-cooking/drying,
c. Obtaining a non-lumping granular cold water swellable starch that when dispersed in water at a temperature of at least 95° C. develops its full viscosity in less than 30 seconds and having a Brookfield viscosity higher than 4500 mPa·s at 3% concentration in demineralised water at 20° C.

The process of the current invention does not involve a viscosity reduction step such as thinning, enzymatic degradation and the like.

In case the starch is prepared by spray-cooking/drying of unmodified (native) or modified starch, an apparatus as is described in U.S. Pat. No. 4,280,851, is applied.

An aqueous starch slurry is sprayed through an atomisation aperture in the nozzle. A heating medium such as steam is injected through another aperture in the nozzle and into the spray. On exiting the nozzle vent aperture, the resultant starch is in a finely sized atomised state and is easily dried in the spray-drying tower. The dried starch can be recuperated in bags to be readily used in applications or it can be re-injected to the top of the tower, such that the trajectory of that recirculating dry powder crosses the spray pattern of the spray-cooked nozzle in order to produce agglomerated particles. The agglomerated particles are recuperated in an external fluid bed. The product from the fluid bed was sieved in a sifter and the oversize fraction was disrupted in a mill. The agglomeration and the particle size distribution of agglomerated starch can be controlled by the nozzle configuration and by the application of a sifter and a suitable mill to screen off and to mill an oversized fraction. The average particle size is closely related to the aperture of the top screen to be used in the sifter.

Furthermore the process parameters are correlated to the type of starch, and each type of starch has well-defined process parameters.

The process parameters for applying stabilised starch n-octenyl succinate (e.g. C⋆EmTex 06328) as base material are specified in example 1. The thus obtained product is non-lumping granular cold water swellable starch that when dispersed in water at a temperature of at least 95° C. develops its full viscosity in less than 30 seconds (at a concentration of at least 3%). (see FIG. 1) Its full viscosity is developed at significant lower concentrations, ie. at concentrations that are about 25% by weight lower than concentrations of products normally needed to develop same viscosity.

For example at 20° C., only 3.1% (w/w) of starch of current invention is needed to develop a Brookfield viscosity of more than 5880 mPa-s, whereas a spray-cooked/dried low crossbonded hydroxypropyl water cold water swelling starch (e.g. C⋆HiForm A 12742) is added in amount of 4.2% (w/w %) for obtaining at 20° C. a Brookfield viscosity of 4780 mPa-s.

The spray-cooking/drying process produces pregelatinised starches known as cold water swellable starches and results in complete starch granule integrity.

B a further embodiment, the current invention relates to a process comprising the following steps:
a. Bleaching of starch,
a₂. Chemically modifying starch,
b. Treating the starch wherein said treatment is selected from the group consisting of spray-cooking/drying, roll-drying, pregelatinisation with aqueous alcohols and combinations thereof, preferably spray-cooking/drying,

The chemical modification of starch includes include without limitation crosslinked starches, acetylated and organically esterified starches, hydroxyethylated and hydroxypropylated starches, phosphorylated and inorganically esterified starches, cationic, anionic, oxidized starches, zwitterionic starches, and succinate and substituted succinate derivatives of starch, or a combination thereof.

In a further preferred embodiment, the current invention further relates to a process comprising the following steps:
a₁. Bleaching of starch,
a₂. n-alkenyl-succinylation with n-alkenylsuccinic anhydride, preferably n-octenyl-succinylation with n-octenylsuccinic anhydride,
b. Treating the starch wherein said treatment is selected from the group consisting of spray-cooking/drying, roll-drying, pregelatinisation with aqueous alcohols and combinations thereof, preferably spray-cooking/drying,
c. Obtaining a non-lumping granular cold water swellable starch that when dispersed in water at a temperature of at least 95° C. develops its full viscosity in less than 30 seconds (at a concentration of at least 3%) and wherein the order of step a₁) and a₂) is interchangeable, or wherein step a1) and a₂) occur simultaneously.

The process of the current invention does not involve a viscosity reduction step such as thinning, enzymatic degradation and the like.

Furthermore, the process of the current invention relates to a process wherein in step a₁) bleaching is taking place with reactant that is capable of forming active chlorine under alkaline conditions.

The addition of active chlorine can occur before, during or after the chemical modification reaction (e.g. n-octenyl-succinylation). The addition of active chlorine during or after the chemical modification is preferred because of a more pronounced stabilization effect with the same treatment level of chlorine.

The active chlorine can be obtained from hypochlorite which may be used as sodium hypochlorite, potassium hypochlorite, calcium or magnesium hypochlorite. The hypochlorite may also be replaced with a combination of reactants which are capable of forming active chlorine in situ, e.g. peracetic acid and/or hydrogen peroxide in the presence of excess chloride ions.

In a typical preferred embodiment, step a₁) and a₂) (=bleaching and n-octenyl succinylation) of the process disclosed in the current invention can be performed according to the process disclosed in EP 0811633.

The active chlorine is present in an amount of from 100 to 4000 ppm, preferably 500-2000 ppm and the alkaline conditions are defined by a pH between 7.5 and 11.5, preferably between 8.5 and 10.5.

In general the reaction conditions (chlorine level, time, temperature, pH) have to be controlled in such a way that no starch degradation and no substantial formation of carboxyl groups (<0.1%) occur.

Typical reaction times and temperatures are between 0.25 to 5 hours and between 10 and 55° C. respectively.

A further advantage of the process of the present invention is that the hypochlorite reaction is performed under alkaline conditions and that a number of the other possible cross-bonding reaction are also normally performed under alkaline conditions so that the reactions can be performed simultaneously or consecutively without the need for changing the pH between the steps. Thus a one-pot process becomes possible.

The current invention further relates to a process comprising the following steps:
a₁. Bleaching of starch with active chlorine present in an amount of from 100 to 4000 ppm at a pH between 7.5 and 11.5
a₂. n-octenyl-succinylation with n-octenylsuccinic anhydride,
b. Spray-cooking/drying of bleached n-octenyl succinylated starch,
   Wherein the order of step a₁) and step a₂) is interchangeable or wherein step a1) and step a₂) occur simultaneously, preferably step a₁) and step a₂) occur simultaneously, more preferably step a₂) occurs before step a₁).

Furthermore the current invention relates to the use of non-lumping granular cold water swellable starch that when dispersed in water at a temperature of at least 95° C. develops its full viscosity in less than 30 seconds (at a concentration of at least 3%) in food products, feed products, cosmetics, pharma products, agrochemicals, and industrial applications.

Said food products are selected from the group consisting of soups, sauces, desserts, dressings, bakery products, and sauce binders. The feed products are selected from the group consisting of pet foods, fish feed, and piglet feed. The pharma products are selected from the group consisting of excipient in tablets, thickeners for syrups, and liquors.

In addition, the current invention relates to the use of non-lumping granular cold water swellable starch that when dispersed in water at a temperature of at least 95° C. develops its full viscosity in less than 30 seconds (at a concentration of at least 3%) to reduce skin formation.

The current invention has the following advantages:
New generation of starchy products is obtained.
New generation of cold water swellable starches
The products are non-lumping and the full viscosity is immediately developed.
The products develop high viscosity at very low concentration (about 3% weight in water)
The products have versatile non-limiting application fields in food and non-food products.

The current invention is illustrated by the following, non-limiting example.

### EXAMPLE 1

Process:

The product applied as base starch material was cook-up C⋆EmTex 06328 (Cerestar).

The product was processed according to the parameters displayed in table 1.

TABLE 1

| | | Process System |
|---|---|---|
| | | pilot, wide body, |
| Type | | straight through agglomeration |
| steam pressure | bars | 8-12 |
| (spitting-free conditions) | | |
| steam mass flow | kg/h | 430-600 |
| specific steam consumption | — | 0.65-0.91 |
| (steam/slurry | | |
| mass ratio) | | |
| air inlet temperature | ° C. | 240 |
| air outlet temperature | ° C. | 85-92 |
| mass flow air | kg/h | 7300-7700 |
| fine grade/ | | agglomerated |
| agglomerated grade | | |

This product is non-lumping, see FIG. 1.

Further characteristics are displayed in table 2.

TABLE 2

| | | | dispersion in |
|---|---|---|---|
| | | dispersion in | boiling |
| | | cold (20° C.) | (>95° C.) |
| | starch | water* | water* |
| | concentration | Brookfield viscosity | |
| CWS Starches | (w/w %) | after 1 hour at 20° C. | |
| C⋆EmTex 06328 | 3.1 | 5,887 ± 105 | 9,660 ± 506 |
| spray-cooked/dried | | mPa · s | mPa · s |

*average of n = 3 replicates.

C⋆EmTex 06328 spray-cooked/dried is the preferred product of the current invention (FIG. 1).

Brookfield Analysis: Concentration in w/w %% anhydrous starch (moisture content is measured with an infra-red moisture balance set at 130° C. for 20 minutes).

In a 400 mL beaker, containing 250 g still mineral water (either at 20° C. or >95° C.), a vortex was created by magnetic stirring (800 rotations.min⁻¹). The required amount of starch was poured via a conical cylinder (20 mm bottom diameter), 60 mm above the beaker, directly into the vortex. The magnetic stirring was stopped after one minute and the beaker was allowed to stand 1 hour in a water-bath set at 20.0±0.1° C. The viscosity was measured with a Brookfield DV-II (spindle 2) at a shear rate of 10 s⁻¹.

A viscous paste (non-lumping) can be obtained with the spray-cooked/dried starch of the invention at a much lower concentration (3.1%) compared to other CWSS which needs higher concentration (4.0-4.2%) and form lumps.

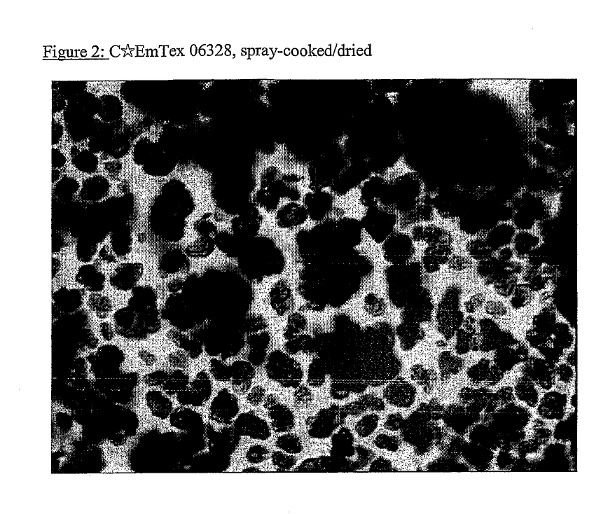

FIG. 2 is a picture taken with the light microscope and showing the intact swollen granules in suspension.

### COMPARATIVE EXAMPLE

Product characteristics of the starch base material (C⋆EmTex 06328) and spray-cooked/dried C⋆EmTex 06328 (of current invention) and alpha-amylase treated n-octenylsuccinate starch are compared in Table 3.

TABLE 3

| | | | Product of Invention |
|---|---|---|---|
| | | Alpha-amylase treated n- | spray-cooked/dried |
| Parameters | C⋆EmTex 06328 | octenylsuccinate starch | C⋆EmTex 06328 |
| Granular state | Granular | Non-granular | Intact, granular |
| Cold water soluble | No | Yes | No |
| starch | | | |
| Gold water swellable | No | No | Yes |
| starch | | | |
| Brookfield viscosity | No cold water | 125-500 mPa · s at 30% | >5000 mPa · s at 3% |
| | viscosity (starch is | concentration, 25° C. | concentration, 20° C. |
| | sedimenting) | | |
| Lump formation (cold | No | Not relevant since it is | No |
| water) | | SOLUBLE | |
| Lump formation | Yes | Not relevant since it is | No |
| (water at 95° C.) | | SOLUBLE | |

1-19. (canceled)

20. A non-lumping granular cold water swellable starch that, when dispersed in water at a temperature of at least 95° C. and at a concentration above 3%, develops its full viscosity in less than 30 seconds.

21. The starch of claim 20, wherein said starch develops its full viscosity in less than 20 seconds.

22. The starch of claim 20, wherein said starch develops its full viscosity in less than 15 seconds.

23. The starch of claim 20, wherein the granules of said starch remain intact upon dispersion.

24. The starch of claim 20, wherein said starch is obtained from a source selected from the group consisting of native leguminous starch, native cereal starch, native root starch, native tuber starch, native fruit starch, modified leguminous starch, modified cereal starch, modified root starch, modified tuber starch, modified fruit starch, waxy type starches, high amylase starches and mixtures thereof.

25. The starch according to claim 24, wherein said modified starch is obtained by a modification selected from the group consisting of bleaching, esterification, etherification, phosphorylation and combinations thereof.

26. A starch according to claim 25, wherein said starch is obtained by bleaching and n-alkenyl-succinylation.

27. The starch of claim 26, wherein said starch is obtained by bleaching and n-octenyl-succinylation.

28. The starch of claim 20, wherein the Brookfield viscosity is higher than 4500 mPa·s.

29. The starch of claim 20, wherein the Brookfield viscosity is higher than 5000 mPa·s.

30. The starch of claim 20, wherein the Brookfield viscosity is higher than 5500 mPa·s.

31. The starch of claim 20, wherein the granules of the starch remain intact upon dispersion.

32. A process for preparing a non-lumping granular cold water swellable starch that, when dispersed in water at a temperature of at least 95° C. and at a concentration of at least 3%, develops its full viscosity in less than 30 seconds, wherein said process comprises the following steps:
a1) bleaching starch; and
b) treating the bleached starch of step a1) with a treatment selected from the group consisting of spray-cooking/drying, roll-drying, pregelatinization with aqueous alcohols and combinations thereof

33. The process of claim 32, wherein said treating in step b) is with spray-cooking/drying.

34. The process of claim 32, further comprising:
a2) chemically modifying said starch.

35. The process of claim 34, wherein the order of steps a1) and a2) are interchangeable.

36. The process of claim 34, wherein steps a1) and a2) occur simultaneously.

37. The process of claim 34, wherein step a2) occurs before step a1).

38. The process according to claim 34, wherein the chemical modification in step a2) is an n-alkenyl-succinylation by n-alkenylsuccinic anhydride.

39. The process according to claim 34, wherein the chemical modification in step a2) is an n-alkenyl-succinylation by n-octenylsuccinic anhydride.

40. The process of claim 32, wherein the bleaching in step a1) takes place in the presence of a reactant that is capable of forming active chlorine under alkaline conditions.

41. The process of claim 40, wherein said active chlorine is present in an amount of from 100 to 4000 ppm.

42. The process of claim 40, wherein said alkaline conditions include a pH of between 7.5 and 11.5.

43. The process of claim 34, wherein said process comprises the following steps:
a1) bleaching starch with active chlorine present in an amount of from 100 to 4000 ppm at a pH between 7.5 and 11.5;
a2) N-octenyl-succinylating said bleached starch with n-octenylsuccinic anhydride; and
b) spray-cooking/drying the bleached n-octenyl-succinylated starch,
wherein steps a1) and a2) occur simultaneously or step a2) occurs before step a1).

44. A food product, feed product, cosmetic, pharma product, agrochemical or industrial product comprising a non-lumping granular cold water swellable starch that, when dispersed in water at a temperature of at least 95° C. and at a concentration of at least 3%, develops its full viscosity in less than 30 seconds.

45. The food product of claim 44, wherein said food product is selected from the group consisting of soup, sauce, dessert, dressing, bakery product, and sauce binder.

46. The feed product of claim 44, wherein said feed product is selected from the group consisting of pet food, fish feed and piglet feed.

47. The pharma product of claim 44, wherein said pharma product is selected from the group consisting of excipient in tablets, thickener for syrups, and liquor.
